(19) United States
(12) Patent Application Publication
(10) Pub. No.: US 2023/0221937 A1
(43) Pub. Date: Jul. 13, 2023

(54) DRIVER INSTALLATION GUIDING CONTROL METHOD, DEVICE REGARDING THE SAME, AND TERMINAL

(71) Applicant: Zhuhai Pantum Electronics Co., Ltd., Zhuhai (CN)

(72) Inventors: Qiang ZHANG, Zhuhai (CN); Lijun ZHAO, Zhuhai (CN); Xiangkui ZHANG, Zhuhai (CN); Tao HOU, Zhuhai (CN); Yan LI, Zhuhai (CN)

(21) Appl. No.: 18/153,995

(22) Filed: Jan. 12, 2023

(30) Foreign Application Priority Data
Jan. 13, 2022 (CN) 202210037386.8

(51) Int. Cl. G06F 8/61; G06F 9/451

(52) U.S. Cl. CPC G06F 8/61; G06F 9/453

(57) ABSTRACT

A driver installation guiding control method includes: obtaining a detection result of whether a terminal is equipped with a Bluetooth module; and according to the detection result, determining a driver installation guiding control user interface to be displayed.

### RELATED APPLICATION(S)

This application claims priority to Chinese Patent Application No. CN202210037386.8 filed with the National Intellectual Property Administration, PRC on Jan. 13, 2022, which is incorporated herein by reference in entirety.

### FIELD OF THE TECHNOLOGY

The present disclosure relates to a technical field of image formation, in particular to a driver installation guiding control method, a driver installation guiding control device, a terminal, and a computer-readable storage medium.

### BACKGROUND

Peripheral device is connected to a terminal, which may be a computer. The peripheral device receives job data sent by the terminal before the peripheral device starts to perform an imaging process, such as printing. Opening and editing of documents in the terminal is usually done through some document operation applications, such as Word, WPS and other applications. To send the document opened by the application in the terminal directly to the peripheral device, a driver is first installed in the peripheral device. A guide program may be set in a driver installation package, and the guide program is run to display searchable image forming devices for the user to choose. However, the user may not know the connection method between the image forming device and the terminal or may not know the connection method to the terminal that is supported by the image forming device. The user may only randomly select an image forming device, and then follow the guide program to perform subsequent operations. However, the connection mode between the terminal and the image forming device may vary, and subsequent operation complexity, success rate, or length of time required may also vary. When the user selects an image forming device whose follow-up operation is complicated, which has a low success rate, or which takes a long time, the user may face complicated follow-up operations or operation failures, or may run into a problem that it takes a long time to complete the driver installation, which brings unpleasant user experience to the user.

### SUMMARY

Embodiments of the present disclosure provide a driver installation guiding control method, a driver installation guiding control device, a terminal, and a computer-readable storage medium, to solve a technical problem that a user may encounter unpleasant user experience when the user does not know the functional configuration of the image forming device during the driver installation process.

In one aspect, the present disclosure provides a driver installation guiding control method. The method includes: obtaining a detection result of whether a terminal is equipped with a Bluetooth module; and according to the detection result, determining a driver installation guiding control user interface to be displayed.

In certain embodiment(s), the detection result indicates that the terminal is equipped with the Bluetooth module and the Bluetooth module is turned on, the method further includes: displaying on the driver installation guiding control user interface a list of image forming devices, and image forming devices as displayed in the list are each equipped with the Bluetooth module.

In certain embodiment(s), the detection result indicates that the terminal is equipped with the Bluetooth module and the Bluetooth module is not turned on, and the method further includes: displaying on the driver installation guiding control user interface a prompt to alert the user to turn on the Bluetooth module.

In certain embodiment(s), the detection result indicates that the terminal is not equipped with the Bluetooth module, and the method further includes: determining driver installation options for installing a driver according to connection information between image forming devices and the terminal; and displaying on the driver installation guiding control user interface the driver installation options.

In certain embodiment(s), the method further includes: obtaining an image forming device selected by a user through the driver installation guiding control user interface; and acquiring wireless network configuration information configured for the image forming device as selected, and sending the wireless network configuration information to the image forming device as selected.

In certain embodiment(s), the method further includes: acquiring a configuration result performed by the image forming device based on the wireless network configuration information; and determining whether to install a driver corresponding to the image forming device as selected according to the configuration result.

In certain embodiment(s), the method further includes: in response to a determination that the configuration result is failure, determining driver installation options according to connection information between the image forming device as selected and the terminal; and displaying the driver installation options for installing the driver.

In another aspect, the present disclosure provides a driver installation guiding control device. The device includes: a memory; and a processor coupled to the memory and configured to perform: obtaining a detection result of whether a terminal is equipped with a Bluetooth module; and according to the detection result, determining a driver installation guiding control user interface to be displayed.

In yet another aspect, the present disclosure provides a non-transitory computer-readable storage medium storing computer program instructions executable by at least one processor to perform: obtaining a detection result of whether a terminal is equipped with a Bluetooth module; and according to the detection result, determining a driver installation guiding control user interface to be displayed.

Certain embodiment(s) of the present disclosure reflect the following beneficial effects.

Detection of whether the terminal device supports the Bluetooth function is prioritized. When the terminal supports the Bluetooth function, the user is guided to select an image forming device that supports the Bluetooth function and complete the subsequent driver installation operation. In comparison to a scenario where the user selects an image forming device that supports a wireless network function and completes subsequent driver installation operations, the driver installation process according to certain embodiment(s) of the present disclosure takes less time, is of a higher success rate, and avoids a problem that the user may not use the wireless network when the terminal communicates with the image forming device, which brings convenience to the user.

### BRIEF DESCRIPTION OF THE DRAWINGS

To more clearly illustrate the technical solutions provided according to certain embodiment(s) of the present disclosure, the accompanying drawings are employed and are introduced below. The accompanying drawings in the following description are directed to certain embodiment(s) of the present disclosure. Those of ordinary skill in the art may obtain other drawings based on these drawings without exerting creative labor.

FIG. 1 is a schematic flowchart of a driver installation guiding control method according to certain embodiment(s) of the present disclosure;

FIG. 2 is a schematic diagram of a driver installation guiding control user interface according to certain embodiment(s) of the present disclosure;

FIG. 3 is a schematic diagram of a driver installation guiding control user interface according to certain embodiment(s) of the present disclosure;

FIG. 4 is a schematic diagram of a driver installation guiding control user interface according to certain embodiment(s) of the present disclosure;

FIG. 5 is a schematic flowchart of a driver installation guiding control method according to certain embodiment(s) of the present disclosure;

FIG. 6 is a schematic flowchart of a driver installation guiding control method according to certain embodiment(s) of the present disclosure;

FIG. 7 is a schematic diagram of a driver installation guiding control device according to certain embodiment(s) of the present disclosure; and

FIG. 8 is a schematic diagram of an electronic device according to certain embodiment(s) of the present disclosure.

### DETAILED DESCRIPTION

To help with understanding the technical solutions of the present disclosure, certain embodiments of the present disclosure are described below in conjunction with the accompanying drawings.

The described embodiments are only some, and not all, embodiments of the present disclosure. Based on the embodiments of the present disclosure, other embodiments obtained by persons of ordinary skill in the art without creative work all belong to the protection scope of the present disclosure.

### IMPLEMENTATION EXAMPLE ONE

The present disclosure in certain embodiment(s) provides a method of controlling driver installation guiding control, which is executed on a terminal, and in particular is executed on a driver installation guiding control program installed on the terminal. The driver installation guiding control program is directly included in the driver to be installed, and may also be set independently. The present disclosure does not intent to limit the particular form of the driver installation guiding control program. The driver is first stored in the terminal in the form of an installation package. After installed successfully, the driver may be used to convert job data provided by an application into data and instructions recognizable by the image forming device.

In certain embodiment(s), and from the principle of imaging, the image forming device may be, but not limited to, a laser printer, an inkjet printer, or an LED printer; from the functional point of view, the image forming device may be, but not limited to, a single-function printer, a copier, or a multi-function printer, where the multi-function includes one or more functions of scanning, faxing, and binding.

In certain embodiment(s), terminal may be a computer such as a personal computer (PC), a smart phone, a tablet, or the like.

In certain embodiment(s), the driver installation package may correspond to various types of image forming devices developed by a certain manufacturer. For example, a model name of P3500 indicates that the model supports devices with USB ports, a model name of P3500N indicates that the model supports devices with USB ports and wired networks, and a model name P3500NW indicates that the model supports devices with USB ports, wired network ports, and wireless network ports.

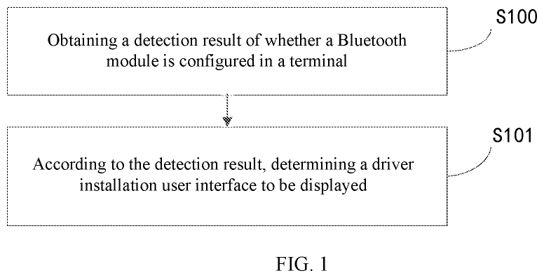

As schematically shown in FIG. 1, the driver installation guiding control method includes one or more of the following steps.

S100: Obtaining a detection result of whether a Bluetooth module is configured in a

terminal.

S101: According to the detection result, determining a driver installation guiding control user interface to be displayed.

After a driver installation guiding control program is started, the driver installation guiding control program sends a detection command to the terminal, to obtain whether the terminal is equipped with a Bluetooth module and whether the Bluetooth module is turned on, and then determines the driver installation guiding control user interface to be displayed according to the detection result.

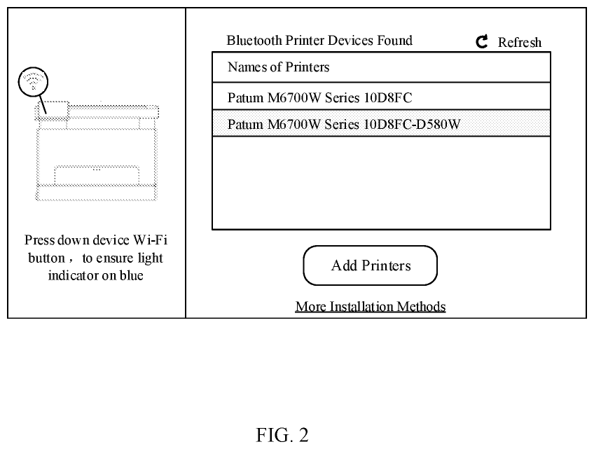

In certain embodiment(s), and as schematically shown in FIG. 2, when it is detected that a Bluetooth module is installed on the terminal and the Bluetooth module is turned on, the driver installation guiding control user interface is used to display a list of preset image forming devices, the image forming devices displayed in the list each include the Bluetooth module.

Before displaying the image forming device list, the driver installation guiding control program searches for an image forming device. After obtaining the list of image forming devices, the driver installation guiding control program combines the model of the image forming device supported by the driver and whether the device is configured with a Bluetooth module, and determines the list of preset image forming devices, where the model of the image forming device as displayed in the list corresponds to the driver.

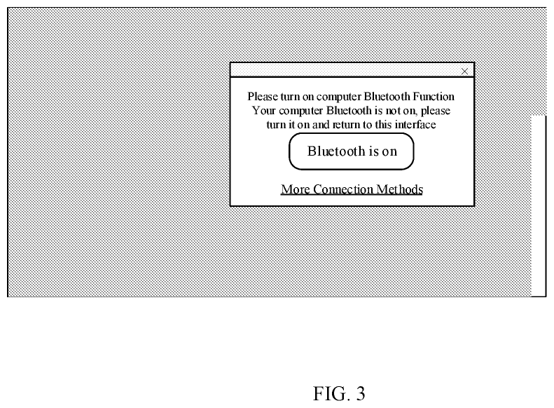

In certain embodiment(s), and as schematically shown in FIG. 3, when it is detected that the terminal is equipped with a Bluetooth module and the Bluetooth module is not turned on, the driver installation guiding control user interface is used to prompt the user to turn on the Bluetooth module.

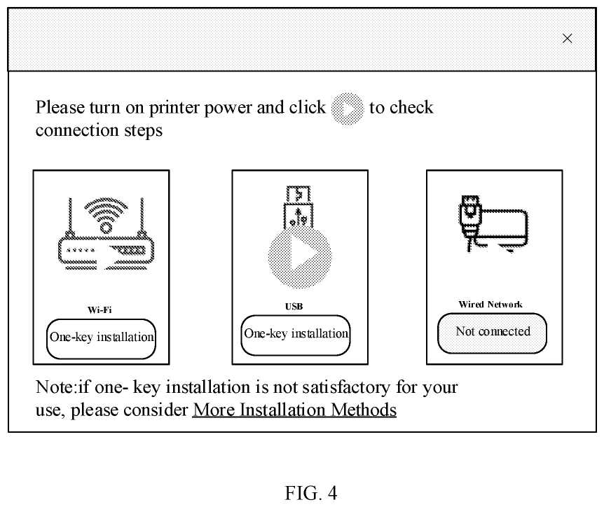

In certain embodiment(s), and as schematically shown in FIG. 4, when it is detected that the Bluetooth module is absent and not configured on the terminal, the driver installation guiding control user interface is used to display driver installation options that may successfully install the driver, and the driver installation options that may successfully install the driver are determined according to connection information between the image forming device and the terminal.

In certain embodiment(s), and as schematically shown in FIG. 3, after the driver installation guiding control user interface prompts the user to turn on Bluetooth, the driver installation guiding control program detects whether the Bluetooth is turned on, and once the Bluetooth is turned on, the driver installation guiding control program searches for the list of preset image forming devices mentioned in reference to FIG. 4.

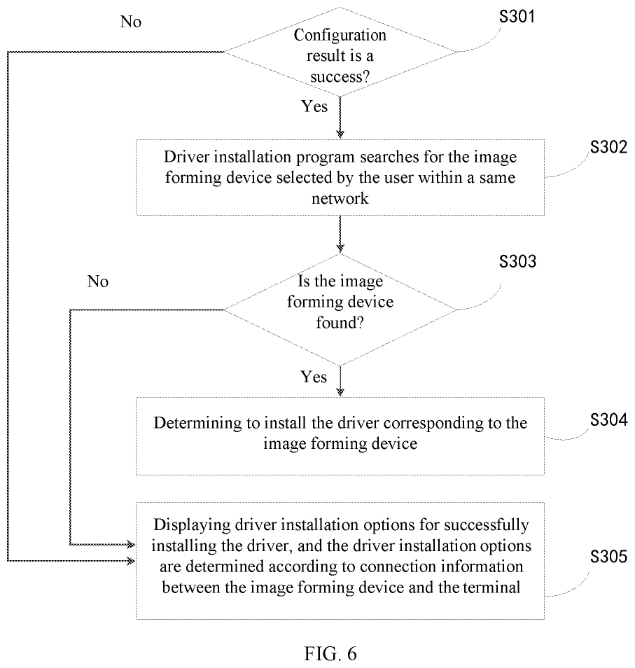

In certain embodiment(s), as shown in FIG. 6, and after the driver installation guiding control program displays the list of image forming devices provided with the Bluetooth module, the method further includes one or more of the following steps.

S201: Acquiring the image forming device selected by the user via the driver installation guiding control user interface.

S202: Obtaining wireless network configuration information configured for the image forming device, and sending the wireless network configuration information to the image forming device.

Obtaining the wireless network configuration information entered by the user via the driver installation guiding control user interface, where the wireless network configuration information includes the wireless network name SSID and password. The wireless network name SSID may be the wireless network name SSID of the wireless network connected to the terminal.

S203: Obtaining a configuration result of wireless network configuration performed by the image forming device based on the wireless network configuration.

After the image forming device receives the wireless network configuration information sent by the terminal, the image forming device tries to connect to the wireless network corresponding to the wireless network configuration information, and feeds back the configuration result to the driver installation guiding control program. The configuration result may indicate that the image forming device successfully connects to the network corresponding to the wireless network configuration information, or that the image forming device fails to connect to the network corresponding to the wireless network configuration information.

S204: According to the configuration result, it is determined whether to install the driver corresponding to the image forming device.

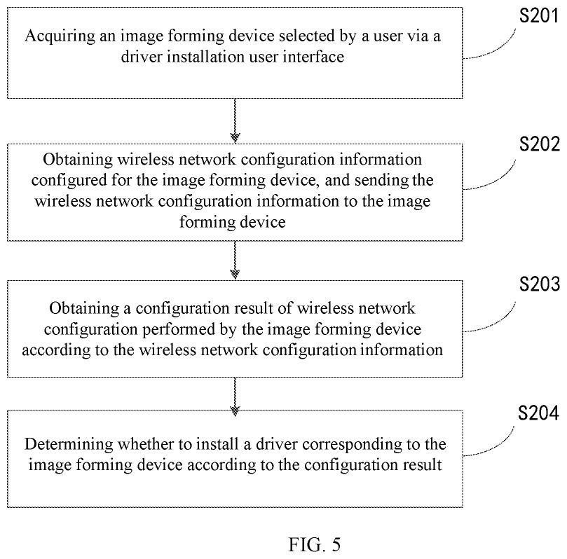

In certain embodiment(s), and as schematically shown in FIG. 5, the method further includes one or more of the following steps.

S301: Is the configuration successful?

If yes, execute S302; if not, execute S305.

S302: The driver installation guiding control program searches for the image forming device selected by the user within the same network.

In certain embodiment(s), the driver installation guiding control program searches for the image forming device selected by the user within the network to which the terminal is connected.

S303: Is the image forming device found?

If yes, execute S304, if not, execute S305

S304: Installing the driver corresponding to the image forming device.

S305: Displaying driver installation options that may successfully install the driver program. The driver installation options that may successfully install the driver program are determined according to the connection information between the image forming device corresponding to the driver and the terminal, as schematically shown in FIG. 4.

In certain embodiment(s), and before S305 is displayed, prompt information may also be output, the prompt information is used to indicate that the network configuration of the image forming device is successful, but the image forming device is not found in the network segment to which the current terminal is connected.

In S305, the driver installation options that may successfully install the driver may be obtained by performing one or more of the following steps. The steps include: obtaining connection information between the image forming device corresponding to the driver and the terminal; determining driver installation options that may successfully install the driver according to the connection information; and displaying the driver installation options that may successfully install the driver.

The connection information between the image forming device corresponding to the driver and the terminal may be a USB connection, a wired connection, or a wireless connection.

The driver installation options that may successfully install the driver may be implemented according to one or more of the following steps.

A driver installation option corresponding to an allowed or permitted connection mode between the terminal and the peripheral device is displayed as of a first state; and a driver installation option corresponding to a disallowed connection mode between the terminal and the peripheral device is displayed as of a second state, where the first state represents that the user is allowed to select the driver installation option, and the second state represents that the user is not allowed to select the driver installation option.

In certain embodiment(s), only the driver installation options that may successfully install the driver are displayed, and the driver installation options that may not successfully install the driver are not displayed.

For an introduction to the driver installation options that may successfully install the driver, relevant contents of the Chinese patent application CN201810790142.0 may be referred to and are not reproduced here for brevity.

In certain embodiment(s), it is first determined as to whether the terminal supports the Bluetooth function. When the terminal is determined to support the Bluetooth function, the user is guided to select an image forming device that supports the Bluetooth function and to complete subsequent driver installation operation. In comparison to a situation where the user chooses an image forming device that supports the wireless network function and completes the subsequent driver installation operations, the driver installation process provided according to certain embodiment(s) of the present disclosure may take less time and be of a higher success rate, and avoids a technical problem where the user may not use the wireless network when the terminal communicates with the image forming device, all of which bring enhanced convenience to the user.

### IMPLEMENTATION EXAMPLE THREE

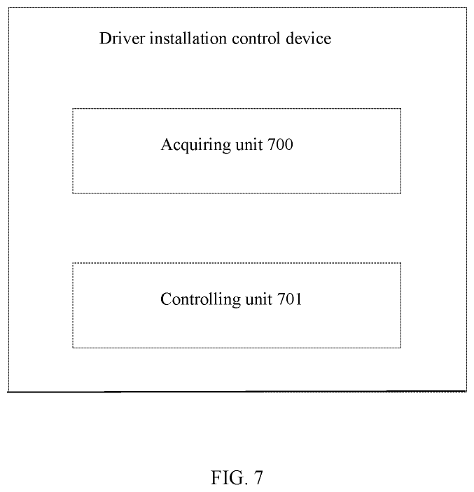

As schematically shown in FIG. 7, the present disclosure in certain embodiment(s) provides a driver installation guiding control device. The driver installation guiding control device includes an acquiring unit 700, configured to acquire a detection result of whether a Bluetooth module is set on the terminal; and a controlling unit 701, configured to determine the driver installation guiding control user interface to be displayed according to the detection result.

In certain embodiment(s), and when the detection result acquired by the acquiring unit 700 is that a Bluetooth module is installed on the terminal and the Bluetooth module is turned on, the driver installation guiding control user interface is used to display a list of preset image forming devices, and the list of preset image forming devices include devices each provided with a Bluetooth module.

In certain embodiment(s), and when the detection result acquired by the acquiring unit 700 is that the terminal is provided with a Bluetooth module and the Bluetooth module is not turned on, the driver installation guiding control user interface is used to prompt the user to turn on the Bluetooth module.

In certain embodiment(s), and when the acquiring unit 700 obtains the detection result that the Bluetooth module is not installed on the terminal, the driver installation guiding control user interface is used to display the driver installation options that may successfully install the driver, and the driver installation options that may successfully install the driver are determined based on the connection information between the image forming device corresponding to the driver and the terminal.

In certain embodiment(s), the acquiring unit 700 is further configured to acquire the image forming device selected by the user on the driver installation guiding control user interface.

In certain embodiment(s), the acquiring unit 700 is further configured to acquire wireless network configuration information configured for the image forming device, and the driver installation guiding control device further includes a sending unit for sending the wireless network configuration information to the image forming device.

In certain embodiment(s), the acquiring unit 700 is further configured to acquire a configuration result of the wireless network configuration performed by the image forming device based on the wireless network configuration.

In certain embodiment(s), the controlling unit 701 is further configured to determine whether to install the driver corresponding to the image forming device according to the configuration result.

When the configuration result obtained by the acquiring unit 700 is a failure, the controlling unit 701 is configured to display the driver installation options that may successfully install the driver, and the driver installation options that may successfully install the driver are determined by the connection information between the image forming device and the terminal.

After the acquiring unit 700 is used to obtain the configuration result of the wireless network configuration performed by the image forming device based on the wireless network configuration, the controlling unit 701 is also used to search for the image forming device, and when the search result fails, the controlling unit 701 displaying driver installation options that may successfully install the driver. The driver installation options that may successfully install the driver are determined according to the connection information between the image forming device corresponding to the driver and the terminal.

In certain embodiment(s), and when the search result is success, the controlling unit 701 is used to determine to install the driver corresponding to the image forming device.

Ways of implementation of implementation example three and corresponding technical effects may be similar to other implementation examples described herein and are not reproduced or repeated for brevity.

### IMPLEMENTATION EXAMPLE FOUR

The present disclosure in certain embodiment(s) provides a terminal, and the terminal may include the driver installation guiding control device described herein, such as the driver installation guiding control device described in relation to implementation example two.

Ways of implementation of implementation example four and corresponding technical effects may be similar to other implementation examples described herein and are not reproduced or repeated for brevity.

### IMPLEMENTATION EXAMPLE FIVE

The present disclosure in certain embodiment(s) also provides a computer-readable storage medium, the computer-readable storage medium includes a stored program causes the device where the computer-readable storage medium is located to execute a driver installation guiding control control method described herein.

Ways of implementation of implementation example five and corresponding technical effects may be similar to other implementation examples described herein and are not reproduced or repeated for brevity.

### IMPLEMENTATION EXAMPLE SIX

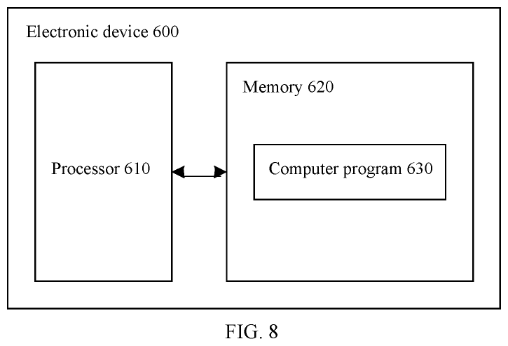

As schematically shown in FIG. 8, the present disclosure in certain embodiment(s) provides an electronic device 600, including a memory 620 and a processor 610. The memory 620 is used to store information including program instructions, and the processor 610 is used to control the execution of the program instructions. The program instructions, when loaded and executed by the processor, implement the steps of the driver installation guiding control control method described herein. To avoid unwanted repeat, details are not reproduced here. Alternatively, when executed by the processor 610, the computer program realizes the functions applied to each model/unit in the image forming control device described herein. To avoid unwanted repeat, details are not reproduced here.

Those skilled in the art may understand that FIG. 8 is only an example illustration of the electronic device 600, and does not constitute a limitation to the computer device 600. The electronic device 600 may include more or fewer components than those shown in the figure, or combine certain components, or different components. For example, the electronic device 600 may also include input and output devices, network access devices, buses, or other suitable components.

The processor 610 may be a central processing unit (CPU), and may also be other general-purpose processors, digital signal processors (DSP), application specific integrated circuits (ASIC), field programmable gate array (FPGA) or other programmable logic devices, discrete gate or transistor logic devices, discrete hardware components, or the like. A general-purpose processor may be a microprocessor or may be any other suitable processor.

The memory 620 may be an internal storage unit of the electronic device 600, such as a hard disk or a memory of the electronic device 600.

The memory 620 may be an external storage device of the electronic device 600, such as a plug-in hard disk equipped on the electronic device 600, a smart memory card (SMC), a secure digital (SD) card, a flash memory card (Flash Card), or the like. The memory 620 may also be a memory on a server, and the computer program 630 stored in the server may be transmitted to other storage modules inside the electronic device by the network, so that the processor 610 may load and run the computer program 630. The memory 620 may also include both an internal storage unit of the electronic device 600 and an external storage device. The memory 620 is used to store computer programs and other programs and data desirable for the electronic device 600. The memory 620 may also be used to temporarily store data that has been output or will be output.

All or part of certain embodiment(s) of the present disclosure may be implemented by software, hardware, firmware or any combination thereof. When implemented using software, certain embodiment(s) of the present disclosure may be implemented in whole or in part in the form of a computer program product. The computer program product includes one or more computer instructions. When the computer instructions are loaded and executed on the computer, the processes or functions according to certain embodiment(s) of the present disclosure may be generated in whole or in part. The computer may be a general-purpose computer, a special purpose computer, a computer network, or any other programmable device. The computer instructions may be stored in a computer-readable medium, or may be transmitted from one computer-readable storage medium to another computer-readable storage medium. For example, the computer instructions may be transmitted from a website, a computer, a server, or a data center by wired connection (such as coaxial cable, optical fiber, Digital Subscriber Line (DSL)) or wireless connection (such as infrared, wireless, microwave, or the like) to another website, another computer, another server, or another data center. The computer-readable storage medium may be any suitable medium that is accessed by a computer, or a data storage device such as a server or a data center integrated with one or more available media. The available medium may be a magnetic medium (such as a floppy disk, a hard disk, or a magnetic tape), an optical medium (such as a high-density Digital Video Disc (DVD), or a semiconductor medium (such as a Solid-State Disk (SSD), or the like.

The above descriptions refer to certain embodiments of the present disclosure, and are not intended to limit the present disclosure. Any modifications, replacements, and/or improvements made within the spirit and principles of the present disclosure are within the scope of protection of the present disclosure.

What is claimed is:

1. A driver installation guiding control method, comprising:
obtaining a detection result of whether a terminal is equipped with a Bluetooth module; and
according to the detection result, determining a driver installation guiding control user interface to be displayed.

2. The driver installation guiding control method of claim 1, wherein the detection result indicates that the terminal is equipped with the Bluetooth module and the Bluetooth module is turned on, the method further comprises:
displaying on the driver installation guiding control user interface a list of image forming devices, and image forming devices as displayed in the list are each equipped with the Bluetooth module.

3. The driver installation guiding control method of claim 1, wherein the detection result indicates that the terminal is equipped with the Bluetooth module and the Bluetooth module is not turned on, and the method further comprises:
displaying on the driver installation guiding control user interface a prompt to alert the user to turn on the Bluetooth module.

4. The driver installation guiding control method of claim 1, wherein the detection result indicates that the terminal is not equipped with the Bluetooth module, and the method further comprises:
determining driver installation options for installing a driver according to connection information between image forming devices and the terminal; and
displaying on the driver installation guiding control user interface the driver installation options.

5. The driver installation guiding control method of claim 2, further comprising:
obtaining an image forming device selected by a user through the driver installation guiding control user interface; and
acquiring wireless network configuration information configured for the image forming device as selected, and sending the wireless network configuration information to the image forming device as selected.

6. The driver installation guiding control method of claim 5, further comprising:
acquiring a configuration result performed by the image forming device based on the wireless network configuration information; and
determining whether to install a driver corresponding to the image forming device as selected according to the configuration result.

7. The driver installation guiding control method of claim 6, further comprising:
in response to a determination that the configuration result is failure, determining driver installation options according to connection information between the image forming device as selected and the terminal; and
displaying the driver installation options for installing the driver.

8. A driver installation guiding control device, comprising: a memory; and a processor coupled to the memory and configured to perform:
obtaining a detection result of whether a terminal is equipped with a Bluetooth module; and
according to the detection result, determining a driver installation guiding control user interface to be displayed.

9. The driver installation guiding control device of claim 8, wherein the detection result indicates that the terminal is equipped with the Bluetooth module and the Bluetooth module is turned on, and the processor is further configured to perform:
displaying on the driver installation guiding control user interface a list of image forming devices, and image forming devices as displayed in the list are each equipped with the Bluetooth module.

10. The driver installation guiding control device of claim 8, wherein the detection result indicates that the terminal is equipped with the Bluetooth module and the Bluetooth module is not turned on, and the processor is further configured to perform:
displaying on the driver installation guiding control user interface a prompt to alert the user to turn on the Bluetooth module.

11. The driver installation guiding control device of claim 8, wherein the detection result indicates that the terminal is not equipped with the Bluetooth module, and the processor is further configured to perform:
determining driver installation options for installing a driver according to connection information between image forming devices and the terminal; and
displaying on the driver installation guiding control user interface the driver installation options.

12. The driver installation guiding control device of claim 9, wherein the processor is further configured to perform:
obtaining an image forming device selected by a user through the driver installation guiding control user interface; and
acquiring wireless network configuration information configured for the image forming device as selected, and sending the wireless network configuration information to the image forming device as selected.

13. The driver installation guiding control device of claim 12, wherein the processor is further configured to perform:
acquiring a configuration result performed by the image forming device based on the wireless network configuration information; and
determining whether to install a driver corresponding to the image forming device as selected according to the configuration result.

14. The driver installation guiding control device of claim 13, wherein the processor is further configured to perform:
in response to a determination that the configuration result is failure, determining driver installation options according to connection information between the image forming device as selected and the terminal; and
displaying the driver installation options for installing the driver.

15. A non-transitory computer-readable storage medium storing computer program instructions executable by at least one processor to perform:
obtaining a detection result of whether a terminal is equipped with a Bluetooth module; and
according to the detection result, determining a driver installation guiding control user interface to be displayed.

16. The non-transitory computer-readable storage medium of claim 15, wherein the detection result indicates that the terminal is equipped with the Bluetooth module and the Bluetooth module is turned on, and the computer program instructions are further executable by the at least one processor to perform:
displaying on the driver installation guiding control user interface a list of image forming devices, and image forming devices as displayed in the list are each equipped with the Bluetooth module.

17. The non-transitory computer-readable storage medium of claim 15, wherein the detection result indicates that the terminal is equipped with the Bluetooth module and the Bluetooth module is not turned on, and the computer program instructions are further executable by the at least one processor to perform:
displaying on the driver installation guiding control user interface a prompt to alert the user to turn on the Bluetooth module.

18. The non-transitory computer-readable storage medium of claim 15, wherein the detection result indicates that the terminal is not equipped with the Bluetooth module, and the computer program instructions are further executable by the at least one processor to perform:
determining driver installation options for installing a driver according to connection information between image forming devices and the terminal; and
displaying on the driver installation guiding control user interface the driver installation options.

19. The non-transitory computer-readable storage medium of claim 16, wherein the computer program instructions are further executable by the at least one processor to perform:
obtaining an image forming device selected by a user through the driver installation guiding control user interface; and
acquiring wireless network configuration information configured for the image forming device as selected, and sending the wireless network configuration information to the image forming device as selected.

20. The non-transitory computer-readable storage medium of claim 19, wherein the computer program instructions are further executable by the at least one processor to perform:
acquiring a configuration result performed by the image forming device based on the wireless network configuration information; and
determining whether to install a driver corresponding to the image forming device as selected according to the configuration result.
